(19) United States
(12) Patent Application Publication
(10) Pub. No.: US 2023/0224295 A1
(43) Pub. Date: Jul. 13, 2023

(54) DISTRIBUTED TWO-FACTOR AUTHENTICATION

(71) Applicant: VMware, Inc., Palo Alto, CA (US)

(72) Inventor: Chirag Radhakrishnan, Pune (IN)

(21) Appl. No.: 17/966,810

(22) Filed: Oct. 15, 2022

(30) Foreign Application Priority Data
Jan. 7, 2022 (IN) 202241000960

(51) Int. Cl. H04L 9/40

(52) U.S. Cl. CPC H04L 63/0838; H04L 63/20

(57) ABSTRACT

Some embodiments provide a method for distributed two-factor authentication in an enterprise network that includes multiple host computers. The method receives a data message destined for a particular security group in a set of security groups that are tagged for two-factor authentication. From a set of security rules defined for the set of security groups, the method identifies a particular security rule associated with the particular security group, the particular security rule specifying a two-factor authentication challenge for authenticating a source of the data message. The method presents the two-factor authentication challenge to the source of the data message to determine whether the source is allowed to access the particular security group.

### BACKGROUND

Today, networking environments can implement distributed firewalls and identify firewalls that can restrict access to resources based on network addresses and user authentication. While these are good first-level defenses, additional security measures, such as additional layers of security, or new lines of defense, would be ideal for ensuring security and protecting critical resources in enterprise environments.

### BRIEF SUMMARY

Some embodiments of the invention provide a method for distributed two-factor authentication in an enterprise network that includes multiple host computers. The method is performed by a host computer (e.g., a server that stores a resource to which a data message is attempting to access) or component(s) of a host computer (e.g., service engines) of the enterprise network in some embodiments, while in other embodiments, the method is performed by any compute node that processes data messages in the enterprise network (e.g., routers, switches, gateway devices, etc.). The method receives a data message destined to a particular security group in a set of security groups (e.g., set of resources) that are tagged for two-factor authentication. From a set of security rules defined for the set of security groups, the method identifies a particular security rule that is associated with the particular security group and that specifies a two-factor authentication challenge for authenticating a source of the data message (e.g., a machine, a user, etc.). The method presents the two-factor authentication challenge to the source of the data message to determine whether the source is allowed to access the particular security group.

In some embodiments, a set of header values of the data message are used to determine the particular security group to which the data message is destined, as well as to identify the particular security rule to enforce on the data message. The particular security rule, in some embodiments, is a firewall rule that specifies a set of attributes for determining whether a data message is associated with a source that is authorized to access the set of security groups. In some such embodiments, the host computer that received the data message (e.g., a firewall engine of the host computer) determines whether the set of header values of the data message match the set of attributes. When the values and attributes are determined to match, in some embodiments, the two-factor authentication challenge is then presented to the source. Otherwise, when the values and attributes are determined to not match, the two-factor authentication challenge is not presented to the source, and the data message is automatically denied access to the particular security group.

The two-factor authentication challenge, in some embodiments, requires the source of the data message to provide a particular time-based one-time password (TOTP) in order to be granted access to the particular security group. For instance, in some embodiments, the host computer that received the data message presents the two-factor authentication challenge using the same protocol as the received data message (e.g., HTTP, SSH, Telnet, etc.), and the source is expected to provide the TOTP in response to the challenge. The particular TOTP, in some embodiments, is generated for the two-factor authentication challenge by a separate process (e.g., a separate application), and the source must obtain the TOTP via the separate process in order to provide the TOTP to the host computer (i.e., via HTTP, SSH, Telnet, etc.). When the source provides the particular TOTP, the data message is granted access to the particular security group. Alternatively, when the source provides a TOTP other than the particular TOTP, the data message is denied access to the particular security group.

The particular TOTP, in some embodiments, is a first TOTP that is valid for a specified duration of time, and once the duration of time has passed, the first TOTP becomes expired. In some embodiments, a second TOTP is generated after the first TOTP has expired, and the second TOTP is then valid for a specified duration of time. The second TOTP is generated upon a request from the source for a new TOTP, in some embodiments. In order to pass the two-factor authentication challenge and be granted access to the particular security group, the source must provide the second (i.e., current) TOTP. If the source provides a TOTP other than the second TOTP (e.g., the expired first TOTP), the data message is denied access to the particular security group.

In some embodiments, the source of the data message is a user of a mobile application on a mobile device attempting to access a protected resource associated with a security group. The two-factor authentication challenge of some such embodiments may require the user of the mobile application to scan a QR code (quick response code) generated by the separate process. The generated QR code, or other TOTP (e.g., a numerical code), can be provided to the user, in some embodiments, via an SMS (short message service) sent to a telephone number associated with the user, via e-mail sent to an e-mail address associated with the user, etc. In some embodiments, the mobile application is a first mobile application, and the user obtains the QR code, or other TOTP, by using a second mobile application that generates QR codes, or other TOTPs, required for the two-factor authentication.

In some embodiments, before the data message is received, each of the host computers in the enterprise network receives a configuration for two-factor authentication to be enforced on data messages destined to security groups in the set of security groups. Each of the host computers uses the received configuration to configure a local two-factor authentication engine, according to some embodiments. The local two-factor authentication engines execute on the host computers, in some embodiments, while in other embodiments, the local two-factor authentication engines are external to the host computers.

In addition to the two-factor authentication configuration, the host computers also receive the set of security rules that are defined for the set of security groups tagged for two-factor authentication and that are to be enforced on data messages destined to security groups in the set of security groups. In some embodiments, the security groups are sets of critical resources identified as requiring two-factor authentication (e.g., based on determinations by network administrators), and the security rules are firewall rules that are enforced by a distributed firewall and that are defined to restrict access to these critical resources. The configuration and security rules are received, in some embodiments, from a network manager (e.g., a management server that is part of a network management and control system for the enterprise network). In some embodiments, the network manager receives definitions of the configuration and security rules from a network administrator and manages distribution of said configuration and security rules to the host computers.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIG. 1 conceptually illustrates a diagram of some embodiments in which a user of a data compute node (DCN) attempts to access a critical resource stored by a set of servers of an enterprise network.

FIG. 2 illustrates a process of some embodiments to implement two-factor authentication when a user tries to access a critical resource associated with a security group.

FIG. 3 illustrates a host computer that in some embodiments is used to establish a distributed architecture for configuring and performing two-factor authentication in a datacenter.

FIG. 4 illustrates a set of stages each depicting a mobile device in some embodiments as a user navigates between a first mobile application that presents the two-factor authentication challenge, and a second mobile application that generates the TOTP to be entered in the first application.

FIG. 5 illustrates a process performed by network managers of some embodiments to distribute configuration data and security rules to host computers in the enterprise network.

FIGS. 6A-6B conceptually illustrate two work-flow diagrams corresponding to the process illustrated by FIG. 5.

FIG. 7 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for distributed two-factor authentication in an enterprise network that includes multiple host computers. The method is performed by a host computer (e.g., a server that stores a resource to which a data message is attempting to access) or component(s) of a host computer (e.g., service engines) of the enterprise network in some embodiments, while in other embodiments, the method is performed by any compute node that processes data messages in the enterprise network (e.g., routers, switches, gateway devices, etc.).

The method receives a data message destined to a particular security group in a set of security groups (e.g., set of resources) that are tagged for two-factor authentication. From a set of security rules defined for the set of security groups, the method identifies a particular security rule that is associated with the particular security group and that specifies a two-factor authentication challenge for authenticating a source of the data message (e.g., a machine, a user, etc.). The method presents the two-factor authentication challenge to the source of the data message to determine whether the source is allowed to access the particular security group.

In some embodiments, a set of header values of the data message are used to determine the particular security group to which the data message is destined, as well as to identify the particular security rule to enforce on the data message. The particular security rule, in some embodiments, is a firewall rule that specifies a set of attributes for determining whether a data message is associated with a source that is authorized to access the set of security groups. In some such embodiments, the host computer that received the data message (e.g., a firewall engine of the host computer) determines whether the set of header values of the data message match the set of attributes. When the values and attributes are determined to match, in some embodiments, the two-factor authentication challenge is then presented to the source. Otherwise, when the values and attributes are determined to not match, the two-factor authentication challenge is not presented to the source, and the data message is automatically denied access to the particular security group.

The two-factor authentication challenge, in some embodiments, requires the source of the data message to provide a particular time-based one-time password (TOTP) in order to be granted access to the particular security group. For instance, in some embodiments, the host computer that received the data message presents the two-factor authentication challenge using the same protocol as the received data message (e.g., HTTP, SSH, Telnet, etc.), and the source is expected to provide the TOTP in response to the challenge. The particular TOTP, in some embodiments, is generated for the two-factor authentication challenge by a separate process (e.g., a separate application), and the source must obtain the TOTP via the separate process in order to provide the TOTP to the host computer (i.e., via HTTP, SSH, Telnet, etc.). When the source provides the particular TOTP, the data message is granted access to the particular security group. Alternatively, when the source provides a TOTP other than the particular TOTP, the data message is denied access to the particular security group.

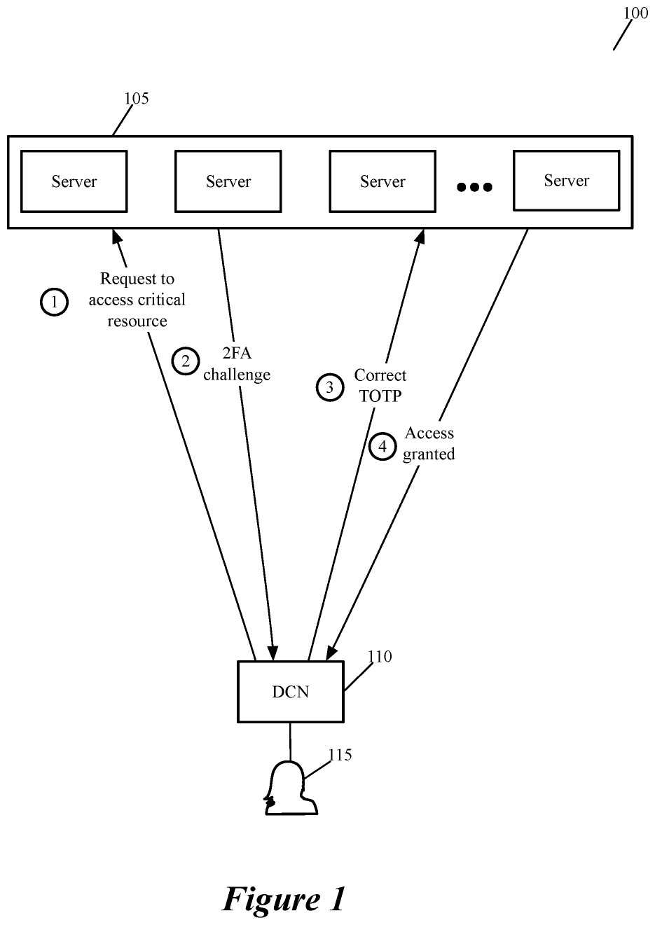

FIG. 1 conceptually illustrates a diagram 100 of some embodiments in which a user 115 of a data compute node (DCN) 110 attempts to access a critical resource stored by a set of servers 105 of an enterprise network. The server set 105, in some embodiments, includes multiple host computers that each execute one or more machines. In some embodiments, the DCN 110 is a virtual machine (VM), container, or other type of compute node executing on a host computer that is accessible to the user. In still other embodiments, the DCN 110 is a mobile device on which an application that enables the user to communicate with the server set 105 is implemented. In some embodiments, the critical resources stored by the server set 105 are stored by the machines (e.g., VMs, containers, Pods, etc.) executing on the servers.

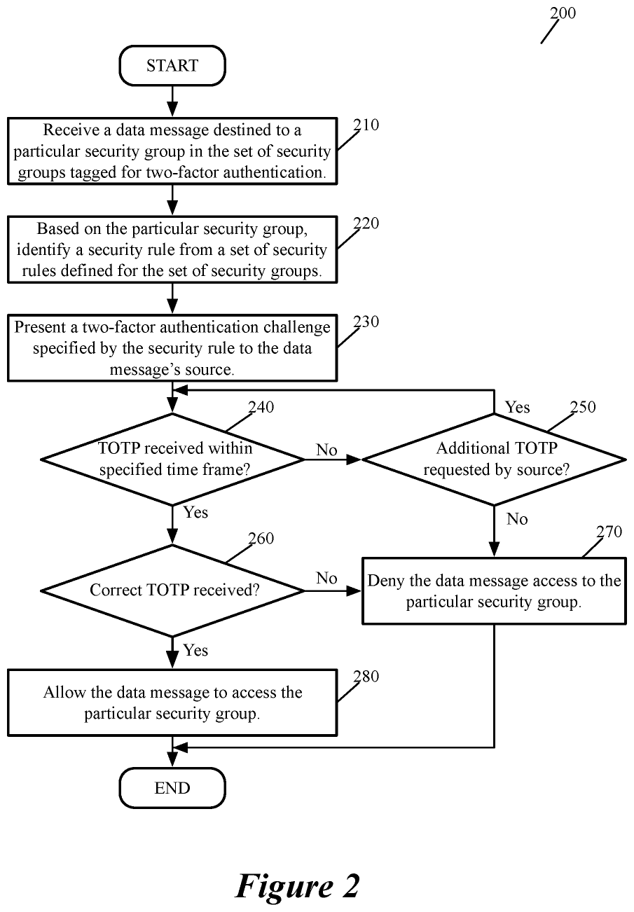

The diagram 100 will be further described with reference to FIG. 2, which illustrates a process of some embodiments to implement two-factor authentication when a user tries to access a critical resource associated with a security group. The process 200 is performed by a server (e.g., host computer) in an enterprise network, in some embodiments. In this example, TOTP is used as the mode for the second factor of the two-factor authentication. Other embodiments may utilize other modes for the second factor of the two-factor authentication, such as fingerprint scanning, facial recognition, SMS (simple message service), etc. In the case of a multi-tenant environment, different servers can be grouped and assigned different modes of two-factor authentication, according to some embodiments.

The process 200 starts by receiving (at 210) a data message destined to a particular security group in a set of security groups defined by a network administrator. For instance, in the diagram 100, the server set 105 receives a request (at the encircled 1) from the user 115 via the DCN 110 to access a critical resource stored by one of the servers (i.e., a machine executing on one of the servers).

Based on the particular security group, the process identifies (at 220) a security rule from a set of security rules defined for the set of security groups. The security rules, in some embodiments, specify source as “any”, and destination as a security group. Accordingly, to identify a matching security rule, the process compares the destination security group specified by the data message with the destination security groups specified by the security rules.

In some embodiments, before identifying the security rule, the process authorizes the source of the data message based on other security rules specified for the server that stores multiple resources including resources other than those associated with the security group. In some such embodiments, the process simply drops the data message if the source is determined to be an unauthorized source. In other embodiments, the source is authorized when they log in to a particular application (e.g., VM) through which they are able to access the enterprise network.

The process presents (at 230) a two-factor authentication challenge specified by the security rule to the data message's source. As mentioned above, the two-factor authentication mode in this example is TOTP, which requires the source to provide a particular TOTP generated for the two-factor authentication challenge within a time frame for which the TOTP is valid in order to be authenticated. Other modes of second-factor authentication, in some embodiments, can include fingerprint scanning, facial recognition, etc.

The process determines (at 240) whether a TOTP generated for the two-factor authentication challenge has been received within a specified time frame (i.e., the time frame during which the TOTP is valid). When the process determines (at 240) that a TOTP has not been received within the specified time frame, the process transitions to determine (at 250) whether an additional (i.e., new) TOTP has been requested by the source. That is, in some embodiments, the generated TOTP is a first TOTP, and once the specified time frame has passed, the first TOTP expires. In some embodiments, the source (e.g., a user) can subsequently request a second TOTP to be generated, which like the first TOTP, is only valid for a specified time frame. In other embodiments, the process denies access to the data message when the TOTP expires, and requires the source to send a new data message to re-request access to the particular security group.

When the process determines (at 250) that an additional TOTP has not been requested by the source, the process transitions to deny (at 270) the data message access to the particular security group. In some embodiments, a notification is sent to the source indicating the request to access the security group has been denied, while in other embodiments, the data message is simply dropped.

When the process determines (at 250) that an additional TOTP has been requested by the source, the process returns to determine (at 240) whether a TOTP has been received within the specified time frame. When the process determines (at 240) that a TOTP has been received within the specified time frame, the process transitions to determine (at 260) whether the received TOTP is the correct TOTP (i.e., matches the current TOTP generated for the two-factor authentication challenge). In other words, if a second TOTP has been generated for the two-factor authentication challenge after the first TOTP has expired, the source must provide the second (i.e., current) TOTP in order to pass the two-factor authentication challenge.

When the process determines (at 260) that the correct TOTP has not been received, the process transitions to deny (at 270) the data message access to the particular security group. That is, if the source provides a TOTP other than the current TOTP (e.g., an incorrect and/or expired TOTP), the data message is denied access to the particular security group. As mentioned above, a notification is sent to the source, in some embodiments, indicating the request is denied, while other embodiments drop the data message without sending a notification. Following 270, the process 200 ends.

When the process instead determines (at 260) that the correct TOTP has been received, the process transitions to allow (at 280) the data message to access the particular security group. Following 280, the process 200 ends.

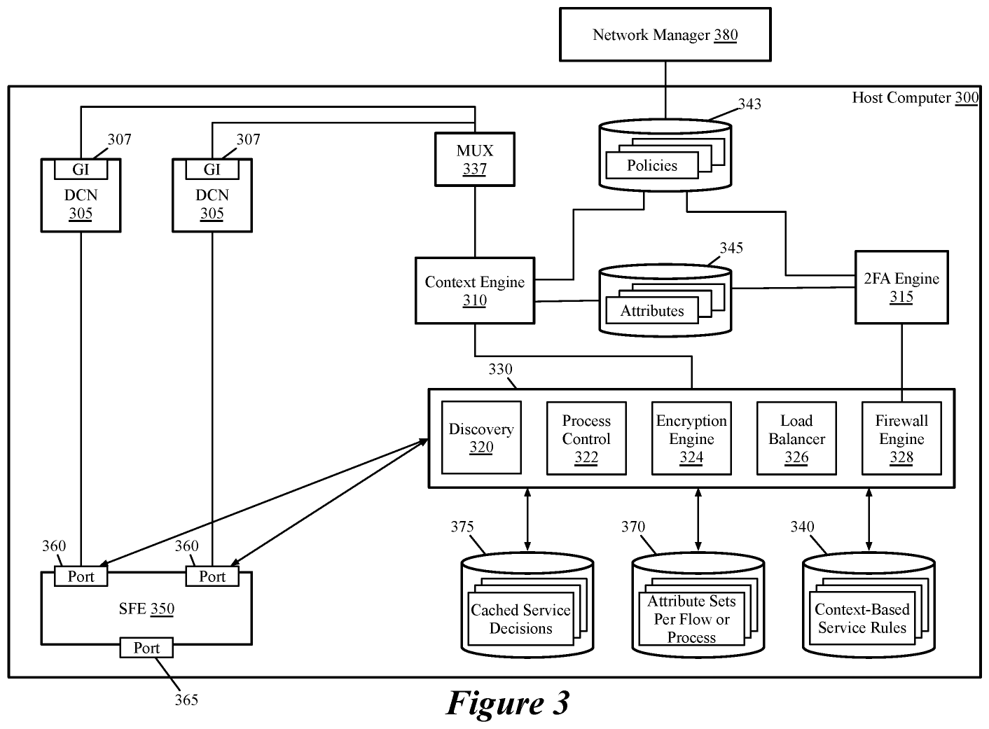

FIG. 3 illustrates a host computer 300 that in some embodiments is used to establish a distributed architecture for configuring and performing two-factor authentication in a datacenter. The host computer 300 includes a context engine 310, a two-factor authentication engine 315, service engines 330, context-based service rule storage 340, and context-attribute storage 345. The service engines 330 in FIG. 3 include a discovery engine 320, a process control engine 322, an encryption engine 324, a load balancer 326, and a firewall engine 328.

The DCNs 305 are endpoint machines executing on a hypervisor of the host computer 300. In some embodiments, the DCNs are virtual machines (VMs), containers in other embodiments, or a mix of VMs and containers in still other embodiments. Additional examples of DCNs include web servers, application servers, database servers, etc. In some cases, the DCNs 305 belong to one entity, e.g., an enterprise that operates the host. In other cases, the host 300 operates in a multi-tenant environment (e.g., in a multi-tenant data center), and different DCNs 305 may belong to one tenant or to multiple tenants.

On each DCN 305, a GI agent 307 executes in order to collect contextual attributes for the context engine 310. In some embodiments, the context engine 310 collects contextual attributes from the GI agents 307 of the DCNs 305 on its host through a variety of different ways. For instance, in some embodiments, the GI agent on a DCN registers hooks (e.g., callbacks) with one or more modules (e.g., kernel-space modules or user-space modules) in the DCN's operating system for all new network connection events and all new process events.

In some embodiments, when a new network connection event occurs, the GI agent 307 receives a callback from its DCN's OS and based on this callback, provides a network event identifier to the context engine 310. The network event identifier provides a set of attributes pertaining to the network event. These network event attributes in some embodiments include a five-tuple identifier (i.e., source port and IP address, destination port and IP address, and protocol) of the requested network connection, process identifier of the process requesting the network connection, a user identifier associated with the requesting process, and a group identifier (e.g., an activity directory (AD) identifier) associated with the requesting process. In this example, all of the communication between the context engine 310 and the GI agent 307 in some embodiments are relayed through the MUX 337. One example of such a MUX is the MUX that is used by the Endpoint Security (EPSec) platform of ESX hypervisors of VMware, Inc.

The host computer 300 also includes a software forwarding element 350, an attribute-mapping storage 370, a connection state cache storage 375, a MUX (multiplexer) 337, and a context-engine policy storage 343. In some embodiments, the context engine 310, the SFE 350, the two-factor authentication engine 315, the service engines 330, the context-based service rule storage 340, the connection state cache storage 375, the context-engine policy storage 343, and the MUX 337 operate in the kernel space of the hypervisor, while the DCNs 305 operate in the hypervisor's user space. In other embodiments, one or more service engines are user space modules (e.g., are service VMs).

While not shown, the DCNs 305 include virtual network interface cards (VNICs) in some embodiments. The VNICs are responsible for exchanging messages between the DCNs 305 and the software forwarding element (SFE) 350. Each VNIC connects to a particular port 360 of the SFE 350. The SFE 350 also connects to a physical network interface card (NIC) (not shown) of the host 300. In some embodiments, the VNICs are software abstractions created by the hypervisor of one or more physical NICs (PNICs) of the host 300.

In some embodiments, the SFE 350 maintains a single port 360 for each VNIC of each DCN 305 executing on the host computer 300. The SFE 350 connects to the host PNIC (through a NIC driver (not shown)) to send outgoing messages and to receive incoming messages. In some embodiments, the SFE 350 is defined to include a port 365 that connects to the PNIC's driver to send and receive messages to and from the PNIC. The SFE 350 performs message-processing operations to forward messages that it receives on one of its ports to another one of its ports. For example, in some embodiments, the SFE 350 tries to use data in the message (e.g., data in the message header) to match a message to flow based rules, and upon finding a match, to perform the action specified by the matching rule (e.g., to hand the message to one of its ports 360 or 365, which directs the message to be supplied to a destination DCN or to the PNIC).

In some embodiments, the SFE 350 is a software switch, while in other embodiments it is a software router or a combined software switch/router. The SFE 350 in some embodiments implements one or more logical forwarding elements (e.g., logical switches or logical routers) with SFEs executing on other hosts in a multi-host environment. A logical forwarding element in some embodiments can span multiple hosts to connect VMs that execute on different hosts but belong to one logical network.

Different logical forwarding elements can be defined to specify different logical networks for different users, and each logical forwarding element can be defined by multiple software forwarding elements on multiple hosts. Each logical forwarding element isolates the traffic of the VMs of one logical network from the VMs of another logical network that is serviced by another logical forwarding element. A logical forwarding element can connect VMs executing on the same host and/or different hosts. In some embodiments, the SFE extracts from a data message a logical network identifier (e.g., a VNI) and a MAC address. The SFE in these embodiments uses the extracted VNI to identify a logical port group, and then uses the MAC address to identify a port within the port group.

Software switches (e.g., software switches of hypervisors) are sometimes referred to as virtual switches because they operate in software and they provide the VMs with shared access to the PNIC(s) of the host. However, in this document, software switches are referred to as physical switches because they are items in the physical world. This terminology also differentiates software switches from logical switches, which are abstractions of the types of connections that are provided by the software switches. There are various mechanisms for creating logical switches from software switches. VXLAN provides one manner for creating such logical switches. The VXLAN standard is described in Mahalingam, Mallik; Dutt, Dinesh G.; et al. (2013-05-08), VXLAN. A Framework for Overlaying Virtualized Layer 2 Networks over Layer 3 Networks, IETF.

The ports of the SFE 350 in some embodiments include one or more function calls to one or more modules that implement special input/output (I/O) operations on incoming and outgoing messages that are received at the ports. Other I/O operations (such as firewall operations, load-balancing operations, network address translation operations, etc.) can be so implemented in some embodiments of the invention. By implementing a stack of such function calls, the ports can implement a chain of I/O operations on incoming and/or outgoing messages in some embodiments. Also, in some embodiments, other modules in the data path (such as the port 365) implement the I/O function call operations instead of, or in conjunction with, the ports 360.

In some embodiments, one or more of function calls of the SFE ports 360 can be to one or more service engines 330 that process context-based service rules in the context-based service rule storage 340. Each service engine 330 in some embodiments has its own context-based service rule storage 340, attribute-mapping storage 370, and connection state cache storage 375. FIG. 3 presents just one context-based service rule storage 340, attribute-mapping storage 370, and connection state cache storage 375 for all of the service engines in order not to obscure the presentation in this figure with unnecessary detail. Also, in some embodiments, when there are multiple DCNs 305 executing on the host computer 300, each DCN 305 has its own instance of each service engine 330 (e.g., its own instance of discovery engine 320, process control engine 322, encryption engine 324, load balancer 326, and firewall engine 328. In other embodiments, one service engine can service data message flows for multiple DCNs on a host (e.g., DCNs for the same logical network).

To perform its service operation for a data message flow, a service engine 330 in some embodiments tries to match the flow identifier (e.g., the five-tuple identifier) and/or the flow's associated context attribute set to the rule identifiers of its service rules in its context-based service rule storage 340. Specifically, for a service engine 330 to perform its service check operation for a data message flow, the SFE port 360 that calls the service engine 330 supplies a set of attributes of a message that the port 360 receives. In some embodiments, the set of attributes are message identifiers, such as traditional five-tuple identifiers. In some embodiments, one or more of the identifier values can be logical values that are defined for a logical network (e.g., can be IP addresses defined in a logical address space). In other embodiments, all of the identifier values are defined in the physical domains. In still other embodiments, some of the identifier values are defined in the logical domain, while other identifier values are defined in the physical domain.

The service engine 330 in some embodiments then uses the received message's attribute set (e.g., the message's five-tuple identifier) to identify the context attribute set that the service engine 330 has stored for this flow in the attribute-mapping storage 370. As mentioned above, the context engine 310 in some embodiments supplies the context attributes for new flows (i.e., new network connection events) and for new processes to the service engines 330, along with a flow identifier (e.g., a five-tuple identifier) or a process identifier. In some embodiments, the process identifiers are associated with an indication of whether the corresponding process has accessed or attempted to access any files containing confidential information.

The context-engine policy storage 343 contains the rules that control the operation of the context engine 310. In some embodiments, the policy storage 343 includes policies provided by the network manager 380. These policies, in some embodiments, can include policies defined for the service engines 330, as well as policies defined for the two-factor authentication engine 315. In some embodiments, the policies also include policies that direct the context engine 310 to generate rules for the service engines 330 or to direct the service engines 330 to generate rules (e.g., when a high-threat application runs on a VM, directing the encryption engine for all the other VMs on the same host to encrypt their data message traffic). The service engines 330 in these embodiments store the context attributes that they receive from the context engine 310 in the attribute-mapping storage 370.

In some embodiments, the five-tuple identifier for a data message or data message flow is provided directly to the two-factor authentication engine 315 to determine whether the destination specified by the five-tuple identifier is a security group in a set of security groups tagged for two-factor authentication. In some embodiments, the two-factor authentication engine 315 obtains the five-tuple identifier by retrieving it from the context-attribute storage 345. Based on the destination specified by the identifier, the two-factor authentication engine 315, in some embodiments, retrieves an applicable policy from the policies storage 343, while in other embodiments, the two-factor authentication engine 315 notifies the firewall engine 328 that the destination of a particular data message is associated with a security group for which two-factor authentication is required. In response to this notification, the firewall engine 328 retrieves the applicable security rule (e.g., firewall rule) from the context-based service rules to apply to the particular data message.

While illustrated as executing on the host computer 300, the two-factor authentication engine 315 executes outside of the host computer 300 in other embodiments. In some such other embodiments, the two-factor authentication engine 315 executes on a proxy that intercepts data messages destined to security groups tagged for two-factor authentication, and authenticates the data messages before they are forwarded to their destination.

In some embodiments, a service engine 330 stores the context attribute set for each new flow or new process with that flow's identifier (e.g., five-tuple identifier) or that process' identifier in the attribute-mapping storage 370. In this manner, the service engine 330 can identify the context attribute set for each new flow that it receives from the SFE ports 360 by searching its attribute-mapping storage 370 for a context record that has a matching flow identifier. The context record with the matching flow identifier includes the context attribute set for this flow.

Some or all of the service engines 330 in some embodiments pull the context attribute sets for a new flow or new process from the context engine 310. For instance, in some embodiments, a service engine 330 supplies a new flow's five-tuple identifier that it receives from the SFE port 360, to the context engine 310. This engine 310 then examines its attribute storage 345 to identify a set of attributes that is stored for this five-tuple identifier, and then supplies this attribute set (or a subset of it that it obtains by filtering the identified attribute set for the service engine) to the service engine 330.

Some embodiments implement the pull model by using a service token to encode the attribute set for a new message flow. When notified of a new network connection event, the context engine 310 in some embodiments (1) collects the context attribute set for the new event, (2) filters this set to discard the attributes that are not relevant for performing one or more services on the flow, (3) stores the remaining filtering attribute subset in the attribute storage 345 along with a service token, and (4) provides the service token to the GI agent 307. The GI agent 307 then causes this token to be passed to the service engine(s) in-band (e.g., in a header of the data message that the agent's VM sends to a destination) or out-of-band (i.e., separately from the data messages that the agent's VM sends to a destination).

When the service engine 330 gets the new flow through the SFE port 360, it supplies this flow's service token to the context engine 310, which uses this service token to identify in its attribute storage 345 the context attributes to supply to the service engine 330. In the embodiments that the SFE port 360 does not provide this service token to the service engine 330, the service engine 330 first has to identify the service token by searching its data stores using the flow's identifier before supplying the service token to the context engine 310.

After identifying the contextual attribute set for a data message flow, the service engine 330 in some embodiments performs its service operation based on service rules that are stored in the context-based service rule storage 340. To perform its service operation, the service engine 330 matches the received attribute subset with corresponding attribute sets that are stored for the service rules. In some embodiments, each service rule in the context-based service rule storage 340 has a rule identifier and an action parameter set.

As mentioned above, the rule identifier of a service rule in some embodiments can be defined in terms of one or more contextual attributes that are not L2-L4 header parameters (e.g., are L7 parameters, process identifiers, user identifiers, group identifiers, process name, process hash, loaded module identifiers, consumption parameters, identifiers indicating an association with confidential data, etc.). In some embodiments, a rule identifier can also include L2-L4 header parameters. Also, in some embodiments, one or more parameters in a rule identifier can be specified in terms of an individual value or a wildcard value. Also, in some embodiments, a rule identifier can include a set of individual values or a group identifier, such as a security group identifier, a compute construct identifier, a network construct identifier, etc.

To match a received attribute set with the rules, the service engine 330 compares the received attribute set with the associated identifiers of the service rules stored in the context-based service rule storage 340. Upon identifying a matching rule, the service engine 330 performs a service operation (e.g., a firewall operation, a load balancing operation, an encryption operation, other middlebox operation, etc.), based on the action parameter set (e.g., based on Allow/Drop parameters, the load balancing criteria, encryption parameters, redirect parameters, etc.) of the matching rule.

In some embodiments, the context-based service rule storage 340 is defined in a hierarchical manner to ensure that a message rule check will match a higher priority rule before matching a lower priority rule, when the message's attribute subset matches multiple rules. Also, in some embodiments, the context-based service rule storage 340 contains a default rule that specifies a default action for any message rule check that cannot identify any other service rules; this default rule will be a match for all possible attribute subsets in some embodiments, and ensures that the service rule engine will return an action for all received attribute subsets. In some embodiments, the default rule will specify no service.

Multiple messages can have the same message identifier attribute sets, e.g., when the messages are part of one flow that is associated with one communication session between two machines. Accordingly, after matching a data message with a service rule in the context-based service rule storage 340 based on the message's identified context attribute set, the service engine 330 of some embodiments stores the service rule (or a reference to the service rule) in the connection state cache storage 375, so that it can later use this service rule for subsequent data messages of the same flow. For example, the firewall engine 328 can store firewall rules associated with different security groups in the connection state cache storage 375 for use on other data messages destined to the different security groups tagged for two-factor authentication.

In some embodiments, the connection state cache storage 375 stores the service rule, or a reference to the service rule, that the service engine 330 identifies for different message identifier sets (e.g., for different five-tuple identifiers that identify different data message flows). In some embodiments, the connection state cache storage 375 stores each service rule, or reference to the service rule, with an identifier (e.g., a flow's five-tuple identifier and/or a hash value of the flow's five-tuple identifier) that is generated from the matching message identifier set.

Before checking with the context-based service rule storage 340 for a particular message, the service rule engine 330 of some embodiments checks the connection state cache storage 375 to determine whether this storage has previously identified a service rule for this message's flow. If not, the service engine 330 identifies the contextual attribute set for the message flow, and then checks the context-based service rule storage 340 for a service rule that matches the message's identified attribute set and/or its five-tuple identifier. In the case of data messages destined to a security group tagged for two-factor authentication, the firewall engine 328 receives an identifier or other information associated with the security group from the two-factor authentication engine 315, as mentioned above, and uses this identifier or other information to identify a matching security rule. When the connection state data storage 375 has an entry for the particular message, the service engine 330 performs its service operation, or security operation, based on this service rule's action parameter set.

The action specified by a security rule defined for the security groups requiring two-factor authentication includes presenting a two-factor authentication challenge to the source of the data message. The two-factor authentication challenge is presented to the source using the same protocol as was used to send the data message, according to some embodiments. Examples of such protocols can include HTTP, SSH, and Telnet. When the source is successfully authenticated, the firewall engine is instructed to allow the data message to proceed to its destination.

In some embodiments, the source of the data message is a user of a mobile application on a mobile device attempting to access a protected resource associated with a security group. The two-factor authentication challenge of some such embodiments may require the user of the mobile application to scan a QR code (quick response code) generated by the separate process, enter a TOTP generated by the separate process, or satisfy the second factor in another manner (e.g., fingerprint scan, facial recognition, etc.). The generated QR code, or other TOTP (e.g., a numerical code), can be provided to the user, in some embodiments, via an SMS (short message service) sent to a telephone number associated with the user, via e-mail sent to an e-mail address associated with the user, etc. In some embodiments, the mobile application is a first mobile application, and the user obtains the QR code, or other TOTP, by using a second mobile application that generates QR codes, or other TOTPs, required for the two-factor authentication.

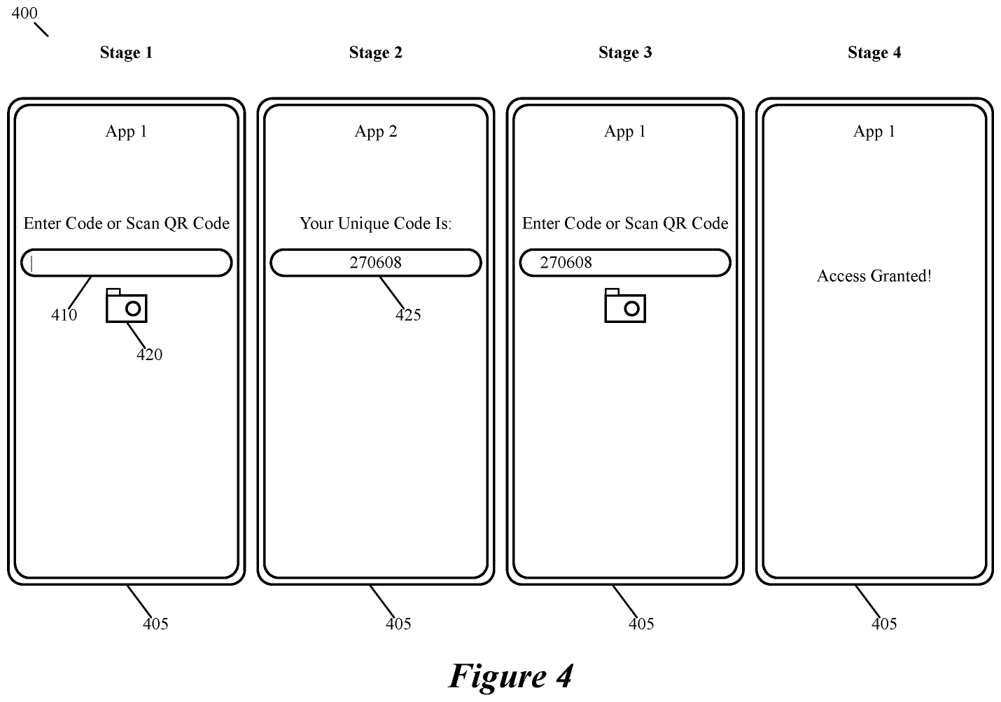

FIG. 4 illustrates a set of stages 400 each depicting a mobile device as a user navigates between a first mobile application that presents the two-factor authentication challenge, and a second mobile application that generates the TOTP to be entered in the first application. In the first stage, a first application “App 1” is displayed by the mobile device 405. This first application instructs a user to enter a code or scan a QR code, and provides a text field 410 for entering the code, and a camera icon 420 that can be selected to scan the QR code (i.e., if the QR code is received on a separate device from which it can be scanned). In some embodiments, this application is an authenticator application that provides the user access to security groups upon successful authentication.

In the second stage, a second application “App 2” is displayed by the mobile device 405. This second application is a self-service portal to which the user can log in and receive unique codes (e.g., TOTPs) for authenticating themselves in the first application. In some embodiments, the first and second applications are managed by a same provider, while in other embodiments, the first and second applications are managed by separate providers. As illustrated, the second application provides the user with a unique code 425.

In the third stage, the user enters the unique code 425 in the text field 410 of the first application to complete the two-factor authentication challenge. If the user were to enter a code other than the code 425, the authenticator first application would deny access. In this example, however, the user has entered the correct code 425, and the first application indicates access has been granted, as illustrated by the fourth stage.

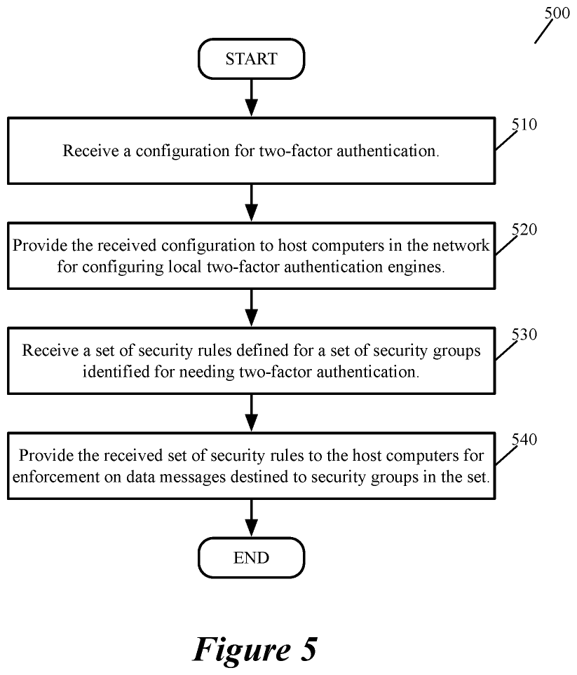

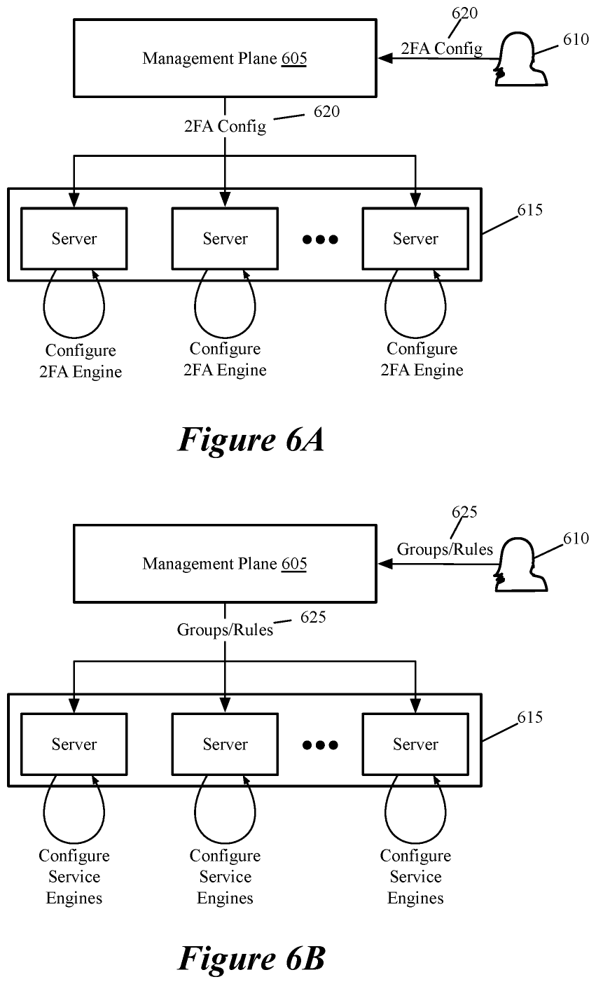

As mentioned above, each of the host computers in the enterprise network receives a configuration for two-factor authentication to be enforced on data messages destined to security groups in the set of security groups, as well as security rules defined for the security groups to be enforced on said data messages. The configuration and security rules are received, in some embodiments, from network managers (e.g., management servers) of the enterprise network. FIG. 5 illustrates a process 500 performed by network managers of some embodiments to distribute configuration data and security rules to host computers in the enterprise network. The process 500 will be described below with references to FIGS. 6A-6B, which conceptually illustrate two work-flow diagrams, 600a and 600b, corresponding to the process 500.

The process 500 starts by receiving (at 510) a configuration for two-factor authentication. The configuration is received, in some embodiments, from a network administrator of the enterprise network. For instance, in the diagram 600a, a network administrator 610 provides a two-factor authentication configuration 620 to a management plane 605, and the management plane 605 then provides the configuration 620 to the set of servers 615. In some embodiments, the management plane 605 includes one or more network managers (e.g., servers) that provide a management layer that allows network administrators 610 to visualize events in a datacenter (e.g., a datacenter for an enterprise network) and specify policies for compute and network resources in the datacenter.

The process 500 provides (at 520) the received configuration to host computers in the network for configuring local two-factor authentication engines. In the diagram 600a, each of the servers in the server set 615 uses the received configuration 620 to configure two-factor authentication engines (not shown). In some embodiments, each server executes its own two-factor authentication engine, while in other embodiments, the two-factor authentication engines execute separately from the server set 615.

The process 500 then receives (at 530) a set of security rules defined for a set of security groups identified for needing two-factor authentication. In some embodiments, the security groups are sets of critical resources identified as requiring two-factor authentication. The diagram 600b illustrates the network administrator 610 providing definitions of the security groups as well as corresponding security rules 625 to the management plane 605, which subsequently provides the security group definitions and security rules 625 to the server set 615. In some embodiments, the two-factor authentication engines are proxies that receive (i.e., intercept) data messages that are destined to security groups stored by the server set 615, and enforce the two-factor authentication method according to the configuration before the data message is forwarded to the server set 615.

The process 500 provides (at 540) the received set of security rules to the host computers for enforcement on data messages destined to security groups in the set. The diagram 600b, for instance, illustrates the server set 615 configuring service engines based on the received security group definitions and security rules 625. In some embodiments, the security rules are firewall rules, and the service engines configured to enforce these rules are distributed firewall engines executed by the servers in the server set 615. Following 540, the process 500 ends.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

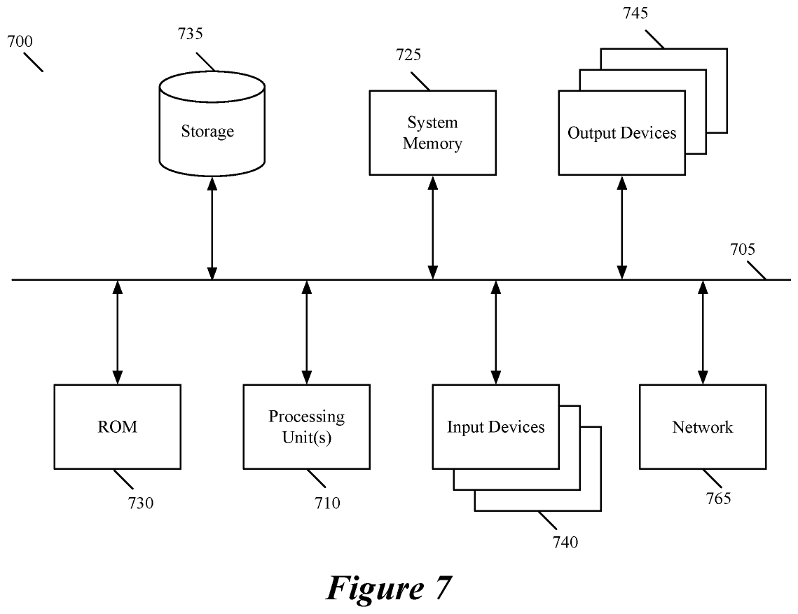

FIG. 7 conceptually illustrates a computer system 700 with which some embodiments of the invention are implemented. The computer system 700 can be used to implement any of the above-described hosts, controllers, gateway, and edge forwarding elements. As such, it can be used to execute any of the above described processes. This computer system 700 includes various types of non-transitory machine-readable media and interfaces for various other types of machine-readable media. Computer system 700 includes a bus 705, processing unit(s) 710, a system memory 725, a read-only memory 730, a permanent storage device 735, input devices 740, and output devices 745.

The bus 705 collectively represents all system, peripheral, and chipset buses that communicatively connect the numerous internal devices of the computer system 700. For instance, the bus 705 communicatively connects the processing unit(s) 710 with the read-only memory 730, the system memory 725, and the permanent storage device 735.

From these various memory units, the processing unit(s) 710 retrieve instructions to execute and data to process in order to execute the processes of the invention. The processing unit(s) 710 may be a single processor or a multi-core processor in different embodiments. The read-only-memory (ROM) 730 stores static data and instructions that are needed by the processing unit(s) 710 and other modules of the computer system 700. The permanent storage device 735, on the other hand, is a read-and-write memory device. This device 735 is a non-volatile memory unit that stores instructions and data even when the computer system 700 is off. Some embodiments of the invention use a mass-storage device (such as a magnetic or optical disk and its corresponding disk drive) as the permanent storage device 735.

Other embodiments use a removable storage device (such as a floppy disk, flash drive, etc.) as the permanent storage device. Like the permanent storage device 735, the system memory 725 is a read-and-write memory device. However, unlike storage device 735, the system memory 725 is a volatile read-and-write memory, such as random access memory. The system memory 725 stores some of the instructions and data that the processor needs at runtime. In some embodiments, the invention's processes are stored in the system memory 725, the permanent storage device 735, and/or the read-only memory 730. From these various memory units, the processing unit(s) 710 retrieve instructions to execute and data to process in order to execute the processes of some embodiments.

The bus 705 also connects to the input and output devices 740 and 745. The input devices 740 enable the user to communicate information and select commands to the computer system 700. The input devices 740 include alphanumeric keyboards and pointing devices (also called “cursor control devices”). The output devices 745 display images generated by the computer system 700. The output devices 745 include printers and display devices, such as cathode ray tubes (CRT) or liquid crystal displays (LCD). Some embodiments include devices such as touchscreens that function as both input and output devices 740 and 745.

Finally, as shown in FIG. 7, bus 705 also couples computer system 700 to a network 765 through a network adapter (not shown). In this manner, the computer 700 can be a part of a network of computers (such as a local area network (“LAN”), a wide area network (“WAN”), or an Intranet), or a network of networks (such as the Internet). Any or all components of computer system 700 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for distributed two-factor authentication in an enterprise network, the enterprise network comprising a plurality of host computers, the method comprising:
receiving a data message destined for a particular security group in a set of security groups that are tagged for two-factor authentication;
from a set of security rules defined for the set of security groups, identifying a particular security rule associated with the particular security group, wherein the particular security rule specifies a two-factor authentication challenge for authenticating a source of the data message; and
presenting the two-factor authentication challenge to the source of the data message to determine whether the source is allowed to access the particular security group.

2. The method of claim 1, wherein the two-factor authentication challenge requires the source to provide a particular time-based one-time password (TOTP) that is (i) generated for the two-factor authentication challenge by a separate process and (ii) accessible to the source via the separate process, wherein:
when the source provides the particular TOTP, the data message is granted access to the particular security group; and
when the source provides a TOTP other than the particular TOTP, the data message is denied access to the particular security group.

3. The method of claim 2, wherein:
the particular TOTP is a first TOTP that is valid for a specified duration of time; and
after the specified duration of time, a second TOTP is generated by the separate process, wherein,
when the source provides the second TOTP, the data message is granted access to the particular security group; and
when the source provides a TOTP other than the second TOTP, the data message is denied access to the particular security group.

4. The method of claim 1, wherein before receiving the data message, the method comprises:
receiving a configuration for two-factor authentication to be enforced on data messages destined to security groups in the set of security groups;
using the received configuration to configure a local two-factor authentication engine; and
receiving the set of security rules (i) defined for the set of security groups tagged for two-factor authentication and (ii) to be enforced on data messages destined to security groups in the set of security groups.

5. The method of claim 4, wherein:
receiving the configuration for two-factor authentication comprises receiving the configuration from a network administrator of the enterprise network; and
receiving the set of security rules comprises receiving the set of security rules from the network administrator.

6. The method of claim 4, wherein:
the local two-factor authentication engine is one of a plurality of two-factor authentication engines in the enterprise network; and
each host computer in the plurality of host computers is associated with at least one two-factor authentication engine in the plurality of two-factor authentication engines.

7. The method of claim 1, wherein each security group in the set of security groups is defined for a particular set of critical resources identified as requiring two-factor authentication.

8. The method of claim 1, wherein the set of security rules comprise distributed firewall rules.

9. The method of claim 1, wherein:
the source comprises a mobile application implemented on a mobile device;
the two-factor authentication challenge comprises a requirement for the source to provide a time-based one-time password (TOTP); and
the TOTP comprises a QR code.

10. The method of claim 9, wherein the mobile application comprises a first mobile application, wherein the separate authentication process comprises a second mobile application implemented on the mobile device.

11. The method of claim 1, wherein receiving the data message destined for the particular security group comprises (i) receiving the data message and (ii) determining from a destination header of the data message that the data message is destined for the particular security group.

12. The method of claim 1, wherein identifying the particular security rule associated with the particular security group further comprises determining whether a set of header values of the data message match a set of attributes specified by the identified security rule, wherein:
when the set of header values are determined to match the specified set of attributes, the two-factor authentication challenge is presented to the source of the data message; and
when the set of header values are determined not to match the specified set of attributes, (i) the two-factor authentication challenge is not presented to the source of the data message and (ii) the data message is automatically denied access to the particular security group.

13. A non-transitory machine readable medium storing a program for execution by a set of processing units, the program for implementing distributed two-factor authentication in an enterprise network that comprises a plurality of host computers, the program comprising sets of instructions for:
receiving a data message destined for a particular security group in a set of security groups that are tagged for two-factor authentication;
from a set of security rules defined for the set of security groups, identifying a particular security rule associated with the particular security group, wherein the particular security rule specifies a two-factor authentication challenge for authenticating a source of the data message; and
presenting the two-factor authentication challenge to the source of the data message to determine whether the source is allowed to access the particular security group.

14. The non-transitory machine readable medium of claim 13, wherein the two-factor authentication challenge requires the source to provide a particular time-based one-time password (TOTP) that is (i) generated for the two-factor authentication challenge by a separate process and (ii) accessible to the source via the separate process, wherein:
when the source provides the particular TOTP, the data message is granted access to the particular security group; and
when the source provides a TOTP other than the particular TOTP, the data message is denied access to the particular security group.

15. The non-transitory machine readable medium of claim 14, wherein:
the particular TOTP is a first TOTP that is valid for a specified duration of time; and
after the specified duration of time, a second TOTP is generated by the separate process, wherein,
when the source provides the second TOTP, the data message is granted access to the particular security group; and
when the source provides a TOTP other than the second TOTP, the data message is denied access to the particular security group.

16. The non-transitory machine readable medium of claim 13, wherein before receiving the data message, the program further comprises sets of instructions for:
receiving, from a network administrator of the enterprise network, a configuration for two-factor authentication to be enforced on data messages destined to security groups in the set of security groups;
using the received configuration to configure a local two-factor authentication engine; and
receiving, from the network administrator, the set of security rules (i) defined for the set of security groups tagged for two-factor authentication and (ii) to be enforced on data messages destined to security groups in the set of security groups.

17. The non-transitory machine readable medium of claim 16, wherein:
the local two-factor authentication engine is one of a plurality of two-factor authentication engines in the enterprise network; and
each host computer in the plurality of host computers is associated with at least one two-factor authentication engine in the plurality of two-factor authentication engines.

18. The non-transitory machine readable medium of claim 13, wherein each security group in the set of security groups is defined for a particular set of critical resources identified as requiring two-factor authentication.

19. The non-transitory machine readable medium of claim 13, wherein the set of security rules comprise distributed firewall rules.

20. The non-transitory machine readable medium of claim 13, wherein the set of instructions for identifying the particular security rule associated with the particular security group further comprises a set of instructions for determining whether a set of header values of the data message match a set of attributes specified by the identified security rule, wherein:
when the set of header values are determined to match the specified set of attributes, the two-factor authentication challenge is presented to the source of the data message; and
when the set of header values are determined not to match the specified set of attributes, (i) the two-factor authentication challenge is not presented to the source of the data message and (ii) the data message is automatically denied access to the particular security group.
